(19) United States
(12) Patent Application Publication
(10) Pub. No.: US 2026/0311391 A1
(43) Pub. Date: Oct. 8, 2026

(54) AUTOMATED GENERATION OF VISUAL REPRESENTATIONS FOR MOTOR CONTROL CENTERS

(71) Applicant: Rockwell Automation Technologies, Inc., Mayfield Heights, OH (US)

(72) Inventors: Todd A. Vance, West Bend, WI (US); Siere Andrell-Jaelyn Jones-Willis, Milwaukee, WI (US)

(21) Appl. No.: 19/169,842

(22) Filed: Apr. 3, 2025

(51) Int. Cl. G06T 11/60; H04L 41/22

(52) U.S. Cl. CPC G06T 11/60; H04L 41/22; G06T 2200/24

(57) ABSTRACT

The methods, systems, and apparatuses described herein provide techniques for automatically generating a visual representation of a motor control center (MCC). An interface service accesses a dataset for the MCC, which includes a configuration of the MCC. The configuration for the MCC includes at least one or more units of the MCC and a form factor and location within the MCC for each unit of the one or more units. The interface service parses the dataset to generate a project file for the MCC that defines the visual representation of the MCC. The visual representation of the MCC defines at least the form factor and the location within the MCC for each of the one or more units. The interface service deploys the project file to a terminal for execution, wherein executing the project file displays the visual representation of the MCC.

### BACKGROUND

Industrial facilities often rely on complex electrical systems to power and control industrial motors used in manufacturing, processing, and other industrial operations. In many such environments, the various devices used to control industrial motors are centralized in structures called motor control centers (MCCs). An MCC typically houses motor starters, circuit breakers, variable frequency drives (VFDs), and other control and protection devices, all of which are configured to ensure safe and efficient operation of the connected motors.

MCCs are often isolated from operators, maintenance personnel, and engineers because of the safety risks associated with the high-voltage signals that MCCs use to drive industrial motors. In such cases, users regularly rely on operator terminals (e.g., a human-machine interface, also referred to as an HMI) to remotely interact with MCCs, to review status information for various devices, and to execute control commands.

As facilities grow in scale and complexity, MCCs may include dozens or even hundreds of individual components distributed across multiple sections. The increasing size and complexity of MCCs present operational and maintenance challenges, particularly with respect to monitoring the status and configuration of individual components. To overcome these challenges, some industrial environments implement visual representations on operator terminals that illustrate an MCC's physical layout, the logical connections between an MCC's devices, and the operational state of an MCC's devices in a way that supports rapid analysis of the MCC.

Unfortunately, creating effective visualizations of an MCC and its individual elements on a terminal interface can require substantial time and effort, particularly where an MCC includes a relatively large number of devices. In particular, the devices of an MCC must be identified and configurations for the devices must be initialized. Further, components may be added to or removed from an MCC, requiring further time and effort to revise the visual representation for the MCC. As such, techniques for effective creating, deploying, and updating a visual representation for an MCC are needed.

### SUMMARY

Described herein are techniques for automatically generating a visual representation of a motor control center (MCC). An interface service accesses a dataset for the MCC, which includes a configuration of the MCC. The configuration for the MCC includes at least one or more units of the MCC and a form factor and location within the MCC for each unit of the one or more units. The interface service parses the dataset to generate a project file for the MCC that defines the visual representation of the MCC. The visual representation of the MCC defines at least the form factor and the location within the MCC for each of the one or more units. The interface service deploys the project file to a terminal for execution, wherein executing the project file displays the visual representation of the MCC.

In some scenarios, parsing the dataset comprises several constituent steps. The steps include (1) identifying, from the dataset, sections of the MCC, (2) selecting, for each of the sections, a section header graphic, (3) selecting, for each of the sections, a top wireway graphic, (4) identifying, for each of the sections, the one or more units, (5) selecting unit graphics for each of the one or more units, wherein the unit graphics comprise configurable visual elements that indicate a state of a corresponding unit, (6) selecting, for each of the sections, a bottom wireway graphic, (7) initializing, for each of the one or more units, the configurable visual elements of the unit graphics, and (8) generating, based on the section header graphic for each of the one or more sections, the top wireway graphic for each of the one or more sections, the unit graphics for each of the one or more units, and the bottom wireway graphic for each of the one or more sections, the project file.

In some scenarios, the configurable visual elements that indicate the state of the corresponding unit comprise a configurable visual element that indicates a network connection state of the corresponding unit and a configurable visual element that indicates a fault state of the corresponding unit.

In some scenarios, network connection information and fault information is periodically obtained for a corresponding unit. In such scenarios, the configurable visual elements that indicate the network connection state and the fault state of the corresponding unit are reconfigured based on the periodically obtained network connection information and fault information.

In some scenarios, each of the section header graphic for each of the one or more sections, the top wireway graphic for each of the one or more sections, the unit graphics for each of the one or more units, and the bottom wireway graphic for each of the one or more sections comprise a scalable vector graphic (SVG).

In some scenarios, the interface service receives a request for the visual representation for the MCC. In such scenarios, each of the accessing of the dataset, the generating of the project file, and the deploying of the project file are performed in response to receiving the request for the visual representation for the MCC.

In some scenarios, the interface service receives a request to update the visual representation for the MCC. In such scenarios, each of accessing the dataset, generating the project file, and deploying the project file are reperformed in response receiving the request to update the visual representation for the MCC.

In some scenarios, deploying the project file to the terminal comprises deploying the project file to the terminal via a cloud-based service. In some scenarios, the dataset is generated during an order and design process for the MCC.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in accordance with some embodiments of the present technology.

FIG. 2 illustrates a method in accordance with some embodiments of the present technology.

FIG. 3 illustrates an operational sequence in accordance with some embodiments of the present technology.

FIG. 4 illustrates a terminal interface in accordance with some embodiments of the present technology.

FIG. 5 illustrates a further terminal interface in accordance with some embodiments of the present technology.

FIG. 6 illustrates a further operational environment in accordance with some embodiments of the present technology.

FIG. 7 illustrates a further method in accordance with some embodiments of the present technology.

FIG. 8 illustrates a computing device used in some embodiments of the present technology.

### DETAILED DESCRIPTION

The methods, systems, and apparatuses described herein provide techniques for automatically generating a visual representation of a motor control center (MCC). An interface service accesses a dataset for the MCC, which includes a configuration of the MCC. The configuration for the MCC includes at least one or more units of the MCC and a form factor and location within the MCC for each unit of the one or more units. The interface service parses the dataset to generate a project file for the MCC that defines the visual representation of the MCC. The visual representation of the MCC defines at least the form factor and the location within the MCC for each of the one or more units. The interface service deploys the project file to a terminal for execution, wherein executing the project file displays the visual representation of the MCC.

In some embodiments, parsing the dataset comprises constituent steps for identifying sections of the MCC, selecting section header graphics for each of the sections, selecting top wireway graphics for each of the sections, identifying units of each of the sections, selecting unit graphics for each of the units, selecting bottom wireway graphics for each of the sections, initializing configurable visual elements of each of the unit graphics, and generating the project file based on the section header graphics, the top wireway graphics, the unit graphics, and the bottom wireway graphics. In such embodiments, the unit graphics include configurable visual elements that indicate the state of the unit corresponding to each unit graphic.

In some embodiments, the configurable visual elements that indicate the state of the corresponding unit comprise a configurable visual element that indicates a network connection state of the corresponding unit and a configurable visual element that indicates a fault state of the corresponding unit.

In some embodiments, network connection information and fault information is periodically obtained for a corresponding unit. In such scenarios, the configurable visual elements that indicate the network connection state and the fault state of the corresponding unit are reconfigured based on the periodically obtained network connection information and fault information.

In some embodiments, each of the section header graphic for each of the one or more sections, the top wireway graphic for each of the one or more sections, the unit graphics for each of the one or more units, and the bottom wireway graphic for each of the one or more sections comprise a scalable vector graphic (SVG).

In some scenarios, the interface service receives a request for the visual representation for the MCC. In such embodiments, each of the accessing of the dataset, the generating of the project file, and the deploying of the project file are performed in response to receiving the request for the visual representation for the MCC. In some embodiments, the interface service receives a request to update the visual representation for the MCC. In such scenarios, each of accessing the dataset, generating the project file, and deploying the project file are reperformed in response receiving the request to update the visual representation for the MCC.

In some embodiments, the terminal is a browser-based terminal. In such embodiments, the project file is deployed to the browser-based terminal for execution. In some embodiments, the terminal is a physical terminal on the same premises as the MCC for which the visual representation is generated. In some scenarios, the terminal is a human-machine-interface (HMI). In some embodiments, the dataset for the MCC is generated during an order and design process for the MCC. In some such embodiments, changes to the components of the MCC after the order and design process are automatically reflected in an update to the dataset. In such embodiments, the updates to the dataset are the basis for an automatic update to the visual representation of the MCC.

The methods, systems, and apparatuses described herein provide for a number of beneficial technical effects. In particular, the techniques herein provide for an interface service that automatically generates a visual representation of an MCC based on a dataset associated with the MCC. Beneficially, the techniques herein provide for efficient defining of an MCC and its components, substantially improved generation of the visual representation for the MCC, and efficient deployment of the project file for execution at terminals.

First, the techniques described herein provide for efficient ingestion of the dataset defining the MCC. Upon receiving the dataset, the interface service automatically parses the dataset to identify the key elements of the MCC and contextual details for those elements. Beneficially, no investigation of the MCC is required in order to obtain a complete understanding of the configuration of an MCC (e.g., what type the MCC is, how many sections the MCC has, how many units of what size are in each section, initial configurations for MCC devices, and the like). Further, where a device is added to or removed from the MCC, the corresponding dataset for the MCC is automatically updated to reflect the addition or removal.

The techniques described herein further provide for the automated selection of graphics to be used in the visual representation. The interface service automatically selects graphics for the MCC components based on the dataset such that, as a whole, the automatically selected graphics combine to form a representation that is visually equivalent to the physical MCC for which a visual representation is being generated. Beneficially, this allows the interface service to automatically generate customized visual representations for MCCs of a wide range of types and have units with a variety of form factors. Additionally, in some cases, the graphics that make up the visual representation include configurable visual elements that indicate the state of corresponding units. During the generation of the project file, the configurable visual elements are initialized to default values. To initialize the configurable visual elements, state information for a corresponding unit is acquired and the configurable visual elements are configured such that the configurable visual elements visually correspond to the state information for the unit.

In some cases, the project file, when executed, directs the terminal to automatically acquire state information for the corresponding units of the MCC, based on which the configurable visual elements can be configured. In some cases, the project file directs the terminal to periodically obtain the state information for units of the MCC and, based on the state information, to periodically update the configurable visual elements of the respective unit graphics for the corresponding units.

The interface service then automatically deploys the project file generated based on the parsing of the dataset for the MCC. The project file is deployed to a terminal (e.g., on-premises terminal, browser-based terminal) for execution, which results in the displaying of the visual representation of the MCC on the terminal. Beneficially, ingestion of the dataset for the MCC, the generation of the project file for the MCC, and the deployment of the project file for the MCC can be performed without oversight. This not only drastically reduces the time and resources required to create a visual representation of an MCC, but also reduces the time and resources required to update or revise the visual representation (i.e., the interface service may automatically reperform the steps described above based on the revision to the dataset).

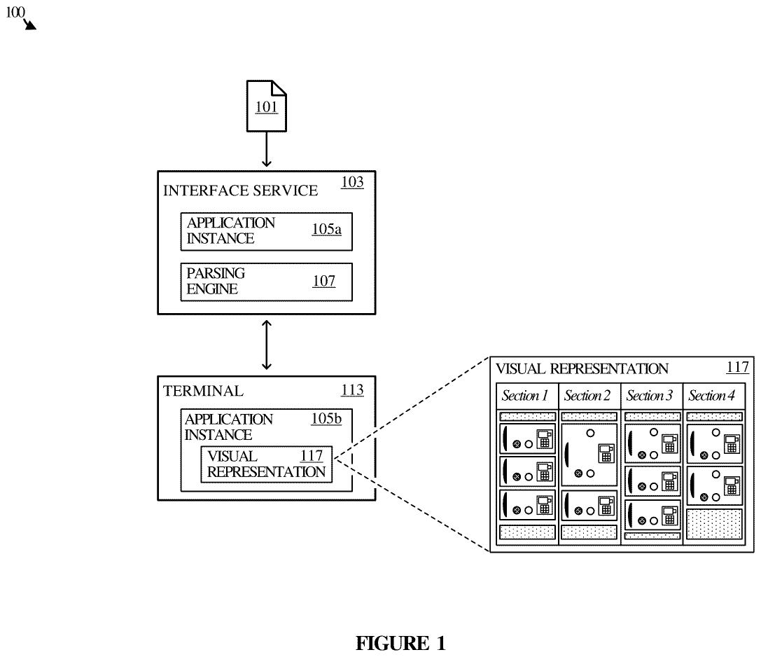

FIG. 1 illustrates operational environment 100 in accordance with some embodiments of the present technology. Operational environment 100 includes dataset 101, interface service 103, and terminal 113. Interface service 103 further includes application instance 105a and parsing engine 107. Terminal 113 further includes application instance 105b, which further includes visual representation 117. Visual representation 117 is further illustrated in FIG. 1 by the element to the right of terminal 113, which shows visual representation 117 in greater detail.

Operational environment 100 is generally representative of an environment in which an interface service (e.g., interface service 103) operates to provide interface-related services. Operational environment 100 may be an industrial environment that includes one or more motor control centers (MCC). In some embodiments, operational environment 100 may be a combination of multiple locations. In some cases, operational environment 100 may be remote to the industrial environment in which the one or more MCCs are located. In some embodiments, operational environment 100 is a distributed environment. For example, interface service 103 may a be a cloud-based service that deploys a visual representation of an MCC (e.g., visual representation 117) to an on-premises terminal (e.g., terminal 113). In another example, interface service 103 may a be a cloud-based service that deploys a visual representation of an MCC to a cloud based-terminal (e.g., terminal 113). In another example, interface service 103 may be a cloud-based service that deploys a visual representation of an MCC to both a cloud-based terminal and an on-premises terminal. In some other embodiments, operational environment 100 may include interface service 103 as an on-premises service that deploys a visual representation of an MCC to an on-premises terminal.

Dataset 101 is generally representative of a structured collection of data that defines a configuration of a motor control center (MCC). The MCC configuration information included in dataset 101 may include type information for the MCC, section information for the MCC, unit information for the MCC, individual device information for MCC devices, inputs, and outputs of the MCC, information for other devices associated with the MCC, anticipated behavior of MCC devices, or a combination thereof. Dataset 101 may be generated as a way to memorialize the components, configurations, and other contextual information relevant to an MCC. In some cases, dataset 101 is generated during a design and ordering process for the MCC. An order and design process may be a purchasing process, and may be a service offered by the producer of the MCC.

In some cases, the order and design process is performed, at least in part, by a terminal (e.g., terminal 113) or other computing device of operational environment 100. In some cases, the order and design process occurs remotely to operational environment 100. For example, a firm that sells custom MCCs to industrial clients may offer an order and design process that allows the clients to individually select various components and configurations for the custom MCC in order to match the needs of the clients. In such cases, dataset 101 is generated during the selection process and memorializes the selections a given clients makes with regard to the MCC the given client has designed. In some cases, the client designing a custom MCC may generate dataset 101 themselves in order to memorialize the information for the MCC. Further, a client may reengage with a design and order process after the initial design and order process is complete in order to add components to or remove components from a custom MCC. In such cases, dataset 101 is updated to reflect the most recent components and configurations of the custom MCC.

Generally, an MCC is an assembly of one or more enclosed sections, each containing a combination of motor control devices, power distribution components, and associated control devices, all housed within a metal enclosure. MCCs are used to centralize the control, protection, and distribution of power to electric motors in industrial environments, simplifying installation, operation, and maintenance. Each section of the MCC includes a number of units.

Each unit within an MCC is a modular compartment that controls a specific motor or group of motors. Units typically consist of circuit protection (such as circuit breakers or fuses), motor starters or contactors, and overload relays to provide both operational control and fault protection. In some cases, each unit includes a visual status indication that communicates some status information for the devices associated with the unit.

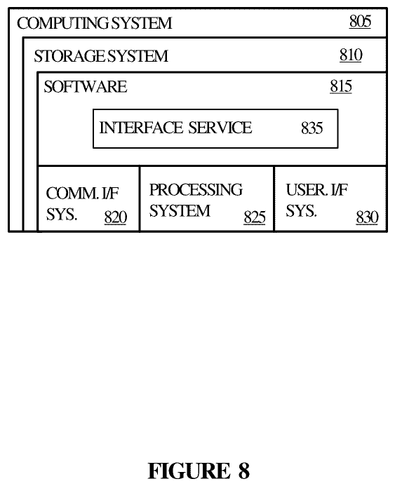

Interface service 103 is generally representative of hardware, software, or firmware for providing the interface-related services in an industrial environment. Interface service 103 may be a computing device, an example of which is given by computing system 805 of FIG. 8. In particular, interface service 103 is configured to receive dataset 101 as an input and in response, to automatically generate and deploy a project file for execution on a terminal, such as terminal 113. When executed, the project file triggers the displaying of a visual representation (e.g., visual representation 117) of an MCC. Visual representation 117, as displayed as a result of executing the project file, is customized to be visually the same as the MCC being represented.

Terminal 113 is generally representative of a hardware interface device in an industrial environment sufficient to display visual representation 117, such as a workstation, human-machine interface (HMI), or ruggedized computer. In general, terminal 113 may be used to monitor, control, or interact with industrial processes and equipment in operational environment 100. In some cases, terminal 113 is a device located on the same premises as one or more MCCs. In some cases, terminal 113 is a device located remotely. In some cases, terminal 113 represents a general computing device configured to provide a browser-based terminal via an internet browser.

Application instance 105a is generally representative of software, hardware, or firmware for orchestrating the processes of interface service 103. In particular, application instance 105a receives dataset 101, leverages parsing engine 107 to process dataset 101, generates a project file based on the parsing, and deploys the project file to terminal 113. In some embodiments, application instance 105a comprises executable instructions that, when executed by interface service 103, provide interface-related services as described herein. In some embodiments, application instance 105a corresponds to another application instance, such as application instance 105b. In such embodiments, application instance 105a generates the project file and deploys the project file to application instance 105b, where the project file is executed and visual representation 117 is displayed.

Parsing engine 107 is generally representative of software, hardware, or firmware that analyzes and interprets structured or semi-structured data, converting it into a format suitable for further processing or storage. In particular, parsing engine 107 processes dataset 101 in order to identify features and components of an MCC. In some embodiments, parsing engine 107 processes dataset 101 in order to identify sections and units of the MCC. Based on the identifying performed by parsing engine 107, application instance 105a generates the project file.

Application instance 105b is substantially the same as application instance 105a. In some cases, application instance 105b is configured to receive the project file from application instance 105a and to execute the project file. Upon executing the project file, visual representation 117 is displayed. In some cases, application instance 105b may receive dataset 101. In some such cases, application instance 105b may be responsible for generating the project file. In such cases, application instance 105b may leverage parsing engine 107 or some other parsing engine in order to generate the project file from dataset 101. In such cases, application instance 105b may deploy the project file to terminal 113 or may otherwise deploy the project file to another terminal or interface device of operational environment 100.

Visual representation 117 is generally representative of a visual illustration that corresponds to a physical MCC. Visual representation 117 is displayed at terminal 113 as a result of executing the project file generated by application instance 105a. As shown in FIG. 1, visual representation includes a detailed example of the visual illustration included in visual representation 117.

In some embodiments, visual representation 117 includes individually selected graphics for section headers for each section of the MCC, top wireway graphics for each section of the MCC, unit graphics for each unit of each section of the MCC, and bottom wireway graphics for each section of the MCC. In some embodiments, the graphics used in visual representation 117 are scalable vector graphics (SVG). In some embodiments, each graphic or SVG includes one or more configurable visual elements that can be set to various values. Based on the various values for the configurable visual elements, one or more portions of the SVG or graphic are visually changed. For example, an SVG or graphic may include a configurable visual element that indicates a fault status for a corresponding device of the MCC. Based on periodically obtained state data for the corresponding device, the configurable visual element for the fault status can be updated. In response to identifying a fault at the corresponding MCC device, the configurable visual element of the SVG or graphic can be changed, resulting in a visual change to the SVG or graphic that demonstrates the occurrence of the fault. For example, an indication light in the SVG or graphic may be illuminated to demonstrate the fault state.

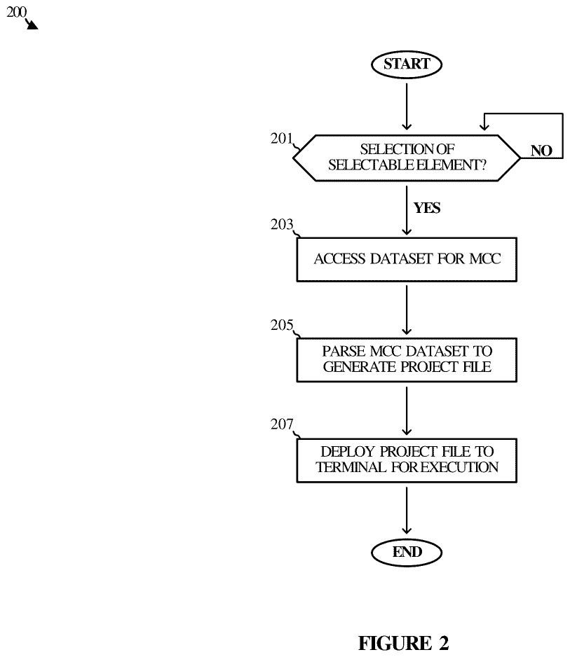

FIG. 2 illustrates method 200 in accordance with an embodiment. Method 200 may be implemented in program instructions in the context of the software and/or firmware elements of interface service 103, application instance 105a, terminal 113, application instance 105b, each of FIG. 1 respectively, or a combination thereof. The program instructions, when executed by one or more processing devices of one or more computing systems (e.g., computing system 805 in FIG. 8), direct the one or more computing systems to operate as follows, referring parenthetically to the steps in FIG. 2, and in the singular to a computing device for the sake of clarity.

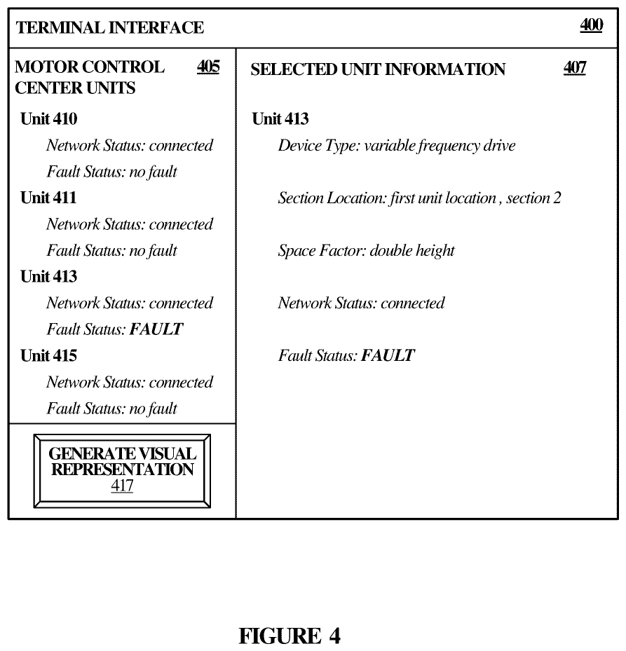

To begin, an interface service (e.g., interface service 103 of FIG. 1) checks for a selection of a selectable element (step 201). The selection may be received via a user interface associated with the interface service, through an interface associated with a terminal (e.g., terminal 113), through another interface, or via another input source. In some cases, the selectable element may be a button or other interactable component of an interface. An example of such an interactable element of an interface is illustrated by generate visual representation 417 of FIG. 4. Where no selection of the selectable element is identified, the interface service continues checking for a selection of the selectable element.

Where a selection of the selectable element is identified, the interface service then accesses a dataset for the MCC (step 203). An example of the dataset is given by dataset 101 of FIG. 1 and is described in detail in the text associated with FIG. 1. The dataset corresponds to a particular MCC. For another MCC, another dataset is acquired. For example, where a user wishes to create a visual representation of a given MCC, the interface service obtains the dataset corresponding to that given MCC. The interface service may read the dataset directly from storage or may query another entity for the dataset (e.g., an entity associated with a design and ordering process for the MCC). In some cases, the interface service may read or retrieve the dataset from data storage resources.

The interface service then parses the dataset in order to generate a project file (step 205). To parse the dataset, the interface service may leverage a parsing engine (e.g., parsing engine 107 of FIG. 1). In some cases, parsing the dataset includes one or more of identifying, from the dataset, sections of the MCC, units for each section of the MCC, devices associated with each unit of the MCC, sizing information for the units of each section, and other configuration information associated with the MCC. The project file generated by the interface service corresponds to the MCC defined in the dataset, and when executed, triggers the display of a visual representation of the MCC (e.g., visual representation 117 of FIG. 1).

The interface service, having generated the project file, deploys the project file to a terminal for execution and subsequent display of the visual representation (step 207). In some cases, the terminal is a physical device on the same premises as the MCC. In some cases, the terminal is located remotely to the MCC. In some cases, the terminal is a browser-based terminal.

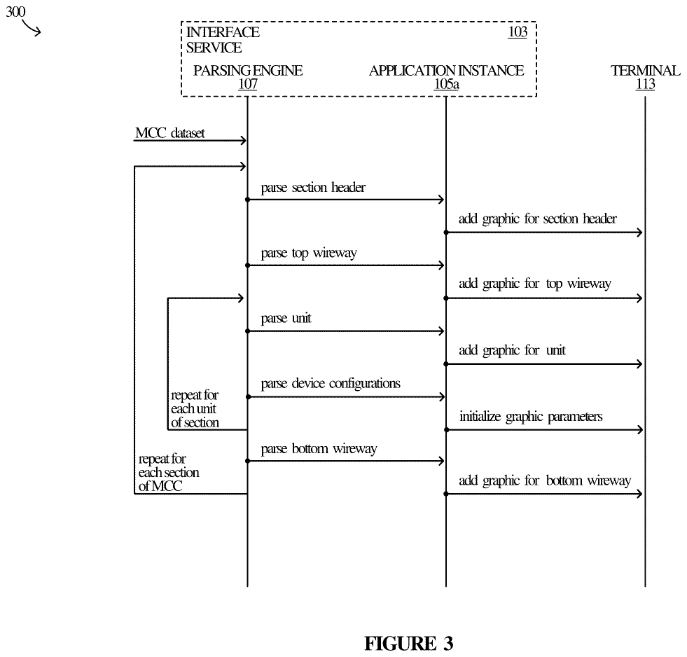

FIG. 3 illustrates operational sequence 300 in accordance with an embodiment. Operational sequence 300 is representative of an example operation of the method steps outline in method 200 of FIG. 2. Operational sequence 300 includes interface service 103 and terminal 113. Interface service 103 as illustrated in FIG. 3 further includes parsing engine 107 and application instance 105a. Each of interface service 103, application instance 105a, parsing engine 107, and terminal 113 are of FIG. 1, respectively, and are each described in detail in the text associated with FIG. 1.

To begin, interface service 103 receives, at parsing engine 107, the MCC dataset (i.e., dataset 101) for a particular MCC. The MCC dataset corresponds to the particular MCC and can be used as the input to interface service 103. Parsing engine 107 parses the dataset in order to facilitate generating a project file. To parse the dataset, parsing engine 107 begins with a first section of the MCC. Parsing engine 107 identifies a first section of the MCC and a section header for the section. Parsing engine 107 informs application instance 105a of the parsed first section and section header for the MCC, in response to which application instance 105a selects a graphic for the section header of the first section. Application instance 105a uses a pre-established library of graphics from which to select the graphic for the section header and for the other portions of the visual representation. In some scenarios, the type of MCC for which a visual representation is being created informs the selection of one of multiple type-specific libraries of graphics. In such cases, there may be a type-specific graphic library corresponding to each type of available MCC. Using a type-specific graphic library to visually represent a specific type of MCC allows for an authentic visualization of the actual MCC instead of a visually generic representation. In some cases, the graphics selected by application instance 105a are scalable vector graphics.

Parsing engine 107 then identifies a top wireway for the first section and informs application instance 105a. In response, application instance 105a selects a graphic for a top wireway for the first section. Parsing engine 107 then identifies a first unit of the first section and informs application instance 105a. In response, application instance 105a selects a unit graphic for the first unit of the first section. Selection of the unit graphic may be based on the parsed form factor (e.g., the size of the unit) information, the type of the MCC, any other visual indicator relevant to the unit, or a combination thereof. In some cases, the unit graphics are selected from a graphic library. In some such cases, the graphic library includes a collection of unit graphics having various visual elements, for example different form factors. Parsing engine 107 then identifies device configurations corresponding to the first unit and informs application instance 105a of the device configurations. Based on the device configurations, application instance 105a initializes graphic parameters for the unit graphics. The initialized graphic parameters for the unit graphics correspond to state information for a device associated with the unit for which the graphic is representative. For example, where a given unit is in a faulted state, the state information for the unit is obtained and the configurable visual element for the unit is configured such that the fault state is visually illustrated. The fault state may be illustrated by an indication light, a text-based indication, or any other visual indication sufficient to communicate state information for the corresponding unit.

Parsing engine 107 then repeats, for a second unit of the first section, the steps performed for the first unit of the first section. These steps are repeated until each unit of the first section has been identified, a unit graphic for each unit is selected, and graphic parameters for each of the unit graphics are initialized. Once the units of the first section are parsed, parsing engine 107 then identifies a bottom wireway of the first section and informs application instance 105a. In response, application instance 105a selects a graphic for the bottom wireway of the first section.

Parsing engine 107 then identifies a second section of the MCC and repeats the steps described herein until a graphic for a section header, a graphic for a top wireway, graphics for each unit, and a bottom wireway graphic are selected (and initialized) for the second section of the MCC. Similarly, parsing engine 107 repeats the steps described above until each section of the MCC has been parsed.

Based on the selected graphics for each section of the MCC, application instance 105a deploys the selected graphics to terminal 113. In some cases, the selections for the graphics of the visual representation are transmitted to terminal 113 as soon as they are selected, at which point another application instance (e.g., application instance 105b) memorializes the selections in the project file. In some cases, application instance 105a selects each of the graphics, generates the project file, and transmits the entirety of the selections to terminal 113 via the project file.

FIG. 4 illustrates terminal interface 400 in accordance with an embodiment. Terminal interface 400 is representative of a graphical user interface of a terminal (e.g., terminal 113 of FIG. 1). Terminal interface 400 includes MCC units 405, selected unit information 407, and generate visual representation 417. MCC units 405 further includes unit 410, unit 411, unit 413, and unit 415. Selected unit information 407 further includes unit 413.

Terminal interface 400 is generally representative of a software-based point of interaction between a user or operator and an industrial control system. In particular, terminal interface 400 is an interface that facilitates interaction between a user or operator and an MCC. Terminal interface 400 may be shown on a terminal (e.g., terminal 113) as a result of executing program instructions on the terminal. In some cases, terminal interface 400 is a browser-based interface. Terminal interface 400 includes visual elements that display various information about industrial control systems, and in particular, information about one or more MCCs. Further, terminal interface 400 may include one or more interactable elements that, when interacted with, trigger various behaviors associated with terminal interface 400, modifies a visible portion of terminal interface 400, or a combination thereof.

Terminal interface 400 displays various selectable elements and information through MCC units 405, selected unit information 407, and generate visual representation 417. MCC units 405 is representative of a collection of interactable elements that correspond to units of an MCC. Each of unit 410, unit 411, unit 413, and unit 415 are selectable elements that, when selected by a user of terminal interface 400, triggers the display of additional information for the MCC and the selected unit via selected unit information 407. Each of unit 410, unit 411, unit 413, and unit 415 correspond to a specific unit of a specific MCC. In some cases and as illustrated in FIG. 4, the graphics representing each of unit 410, unit 411, unit 413, and unit 415 further include configurable visual elements that correspond to status information for a respective unit.

As shown in FIG. 4, each of unit 410, unit 411, unit 413, and unit 415 include network status information and fault status information for each respective unit. The information displayed here in MCC units 405 allows for review of high-level information for the devices associated with each of unit 410, unit 411, unit 413, and unit 415. Notably, the information associated with unit 413 indicates that a faulted state has occurred for an MCC device associated with unit 413. To trigger the display of additional information for the MCC and a selected unit, a user selects one of the units of MCC units 405. As illustrated in FIG. 4, unit 413 has been selected from MCC units 405, triggering the display of information corresponding to unit 413 in selected unit information 407.

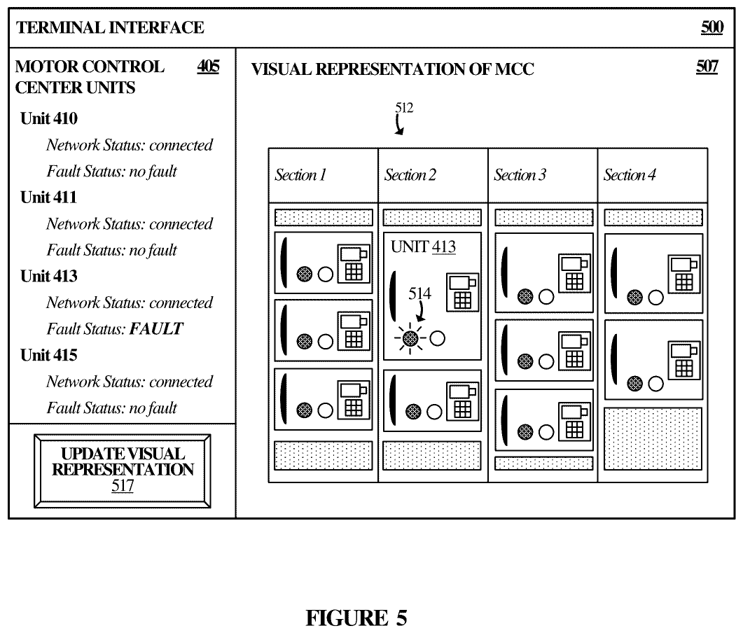

The information displayed in selected unit information 407 that corresponds to unit 413 includes device type information, unit location and sizing information, network status information, and fault status information. In some cases, additional information is included in selected unit information 407, such as information about devices associated with a unit and MCC, configuration information, other kinds of status information for the unit, or other kinds of contextual information for the unit. In particular, the unit and sizing information for unit 413 defines a form factor for the unit. Here, unit 413 is defined as having a double height form factor. The double height form factor is based on a standard unit height associated with the MCC type. The double height form factor of unit 413 is illustrated in visual representation of MCC 507 of FIG. 5. In some cases, a given unit may have a standard form factor, a greater than standard form factor, or a less than standard form factor. In any such case, the visual representation of the MCC to which the units belong shows the form factors of each individual unit.

Generate visual representation 417 is generally representative of an interactable element of terminal interface 400 that, when interacted with, triggers the generation of a visual representation of an MCC (e.g., visual representation 117 of FIG. 1). As shown in FIG. 4, generate visual representation 417 is a button element, but may be other types of interactable interface elements in other scenarios. An example of the results of selecting generate visual representation 417 from terminal interface 400 is demonstrated in terminal interface 500 of FIG. 5.

FIG. 5 illustrates terminal interface 500 in accordance with an embodiment. Terminal interface 500 is representative of a graphical user interface of a terminal (e.g., terminal 113 of FIG. 1). Terminal interface 500 includes MCC units 405, visual representation of MCC 507, and update visual representation 517. MCC units 405 further includes units 410, units 411, units 413, and units 415. Visual representation of MCC 507 further includes MCC section 512. MCC section 512 further includes unit 413. Unit 413 further includes indication 514.

Terminal interface 500 is substantially the same as terminal interface 400 except that in terminal interface 500 of FIG. 5, a selection of an interactable element associated with the generation of a visual representation of an MCC (e.g., generate visual representation 417) has been selected, triggering the display of visual representation of MCC 507. Each of MCC units 405, unit 410, unit 411, unit 413, and unit 415 of FIG. 5, respectively, are substantially the same as MCC units 405, unit 410, unit 411, unit 413, and unit 415 of FIG. 4, respectively.

Upon selection of an interactable element associated with the generation of a visual representation of an MCC, an interface service associated with terminal interface 500 (e.g., interface service 103) obtains a dataset for the MCC (e.g., dataset 101) and parses the dataset to generate a project file for the MCC. The project file is then deployed to a terminal for execution, resulting in the display of visual representation of MCC 507.

Visual representation of MCC 507 includes visual elements that correspond to elements of a physical MCC, such as the headers, sections, wireways, units, status indications, and other elements of the MCC. Notably, visual representation of MCC 507 allows a user or operator to more efficiently review and evaluate the MCC. As shown in visual representation of MCC 507, MCC section 512 includes unit 413. Unit 413 includes indication 514. Here, indication 514 is illustrated as illuminated, indicating a fault status corresponding to the fault status information shown in unit 413 of MCC units 405. Beneficially, visual representation of MCC 507 allows for the expedient review of an entire MCC and all of its constituent components as opposed to the individual review of information for each unit. When visual representation of MCC 507 is first generated, configurable visual elements of each of the unit graphics (e.g., indication 514) are initialized. To initialize the configurable visual elements, state information for the units corresponding to each of the unit graphics is obtained and the configurable visual elements are configured such that the state information is visually illustrated in visual representation of MCC 507. At some point, a periodic acquisition of state information for unit 413 results in the detection of a fault state for unit 413. In such a case, indication 514 is modified such that the fault state of unit 413 is illustrated in visual representation of MCC 507.

Additionally, visual representation of MCC 507 illustrates each of the units therein based on form factor information included in the dataset associated with the MCC. In particular, the form factor information for unit 413 illustrated in selected unit information 407 of FIG. 4 is also shown in visual representation of MCC 507 in that unit 413 of visual representation of MCC 507 is approximately twice the heigh of the other units as a product of the double heigh form factor of unit 413.

Terminal interface 500 further includes update visual representation 517, which is generally representative of an interactive interface element that, when selected, triggers a reperforming of the method steps described herein. Notably, where a change to an MCC occurs (e.g., a device is added to or removed from an MCC), the dataset corresponding to the MCC is updated to reflect the change. When a selection of update visual representation 517 is identified, an interface service (e.g., interface service 103 of FIG. 1) obtains the updated dataset for the MCC, parses the dataset, generates a new project file based on the parsing, and deploys the new project file to a terminal for execution and subsequent display of the updated visual representation.

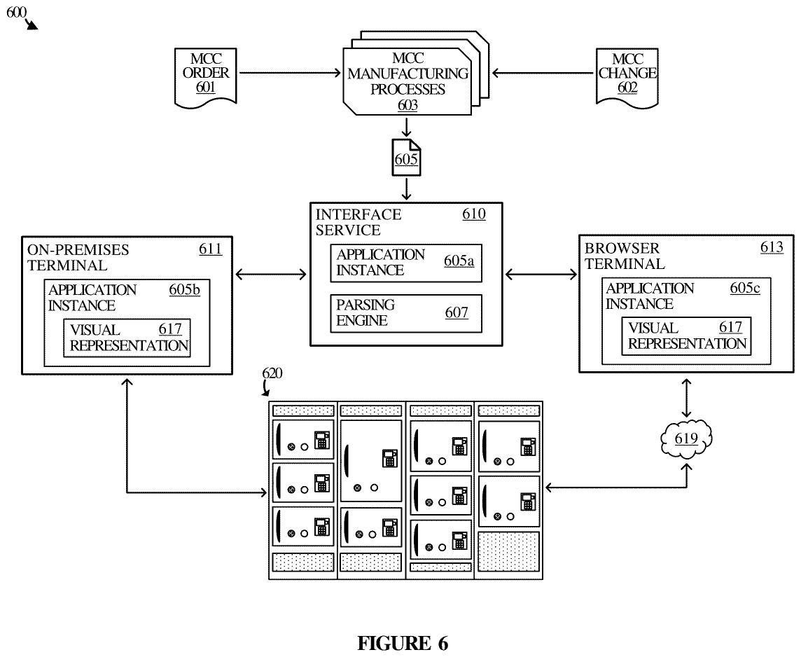

FIG. 6 illustrates operational environment 600 in accordance with an embodiment. Operational environment 600 is representative of an environment in which an embodiment of the current disclosure operates. Operational environment 600 includes MCC order 601, MCC change 602, MCC manufacturing process 603, dataset 605, interface service 610, on-premises terminal 611, browser terminal 613, cloud intermediary 619, and MCC 620.

MCC manufacturing process 603 is representative of design and ordering processes for an MCC. MCC order 601, which is representative of an order for a particular MCC composed of particular components, is submitted to MCC manufacturing processes 603, which generates dataset 605. Dataset 605 is substantially similar to dataset 101 of FIG. 1. MCC change 602 is also submitted to MCC manufacturing processes 603, which may result in an update to dataset 605.

Dataset 605 is submitted to interface service 610 and used as the basis for the generation of a visual representation for an MCC associated with dataset 605 (e.g., visual representation 617). Interface service 610 is generally representative of hardware, software, or firmware for providing the interface-related services in an industrial environment. Interface service 610 may be a computing device, an example of which is given by computing system 805 of FIG. 8. Dataset 605 is received at application instance 605a, which leverages parsing engine 607 to parse dataset 605 and generate the project file for the MCC. When executed, the project file triggers the displaying of visual representation 617 at on-premises terminal 611 via application instance 605b or at browser terminal 613 via application instance 605c.

On-premises terminal 611 is generally representative of a hardware interface device in an industrial environment sufficient to display visual representation 617, such as a workstation, human-machine interface (HMI), or ruggedized computer. In general, on-premises terminal 611 may be used to monitor, control, or interact with industrial processes and equipment in an industrial environment (e.g., operational environment 100). Browser terminal 613 is generally representative of a software-based interface sufficient to display visual representation 617 and to monitor, control, or interact with industrial processes and equipment in an industrial environment (e.g., operational environment 100).

Application instance 605a, application instance 605b, and application instance 605c are each generally representative of software, hardware, or firmware for orchestrating the processes of interface service 610 a displaying visual representation 617. In particular, application instance 605a receives MCC order 601, leverages parsing engine 607 to process dataset 605, generates a project file based on the parsing, and deploys the project file to one or both of on-premises terminal 611 and browser terminal 613. In some embodiments, application instance 605a comprises executable instructions that, when executed by interface service 610, provide interface-related services as described herein. In some embodiments, application instance 605a corresponds to other application instances, such as application instance 605b and application instance 605c. In such embodiments, application instance 605a generates the project file and deploys the project file to one or both of application instance 605b an application instance 605c, where the project file is executed and visual representation 617 is displayed.

MCC 620 is generally representative of a physical MCC in an industrial environment. During the generation of visual representation 617 based on dataset 605, application instance 605a automatically collects network information for each device of the MCC. Based on the network information, status information for each MCC device is obtained and used to initialize configurable visual elements included in the unit graphics of visual representation 617. In cases where the project file is deployed to browser terminal 613, cloud intermediary 619 is used to facilitate a network connection between browser terminal 613 and MCC 620. Where the project file is deployed to on-premises terminal 611, on-premises terminal 611 may be directly connected to MCC 620.

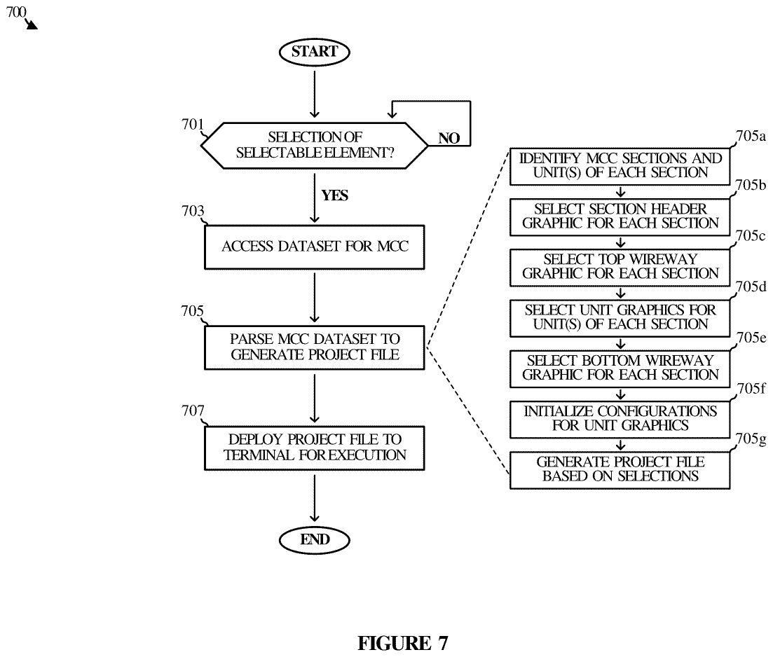

FIG. 7 illustrates method 700 in accordance with an embodiment. Method 700 may be implemented in program instructions in the context of the software and/or firmware elements of interface service 610, application instance 605a, on-premises terminal 611, application instance 605b, browser terminal 613, application instance 605c, each of FIG. 1 respectively, or a combination thereof. The program instructions, when executed by one or more processing devices of one or more computing systems (e.g., computing system 805 in FIG. 8), direct the one or more computing systems to operate as follows, referring parenthetically to the steps in FIG. 7, and in the singular to a computing device for the sake of clarity.

To begin, an interface service (e.g., interface service 610 of FIG. 6) checks for a selection of a selectable element (step 701). The selection may be received via a user interface associated with the interface service, through an interface associated with a terminal (e.g., on-premises terminal 611 and browser terminal 613), through another interface, or via another input source. In some cases, the selectable element may be a button or other interactable component of an interface. An example of such an interactable element of an interface is illustrated by generate visual representation 417 of FIG. 4. Where no selection of the selectable element is identified, the interface service continues checking for a selection of the selectable element.

Where a selection of the selectable element is identified, the interface service then accesses a dataset for the MCC (step 703). An example of the dataset is given by dataset 101 of FIG. 1 and is described in detail in the text associated with FIG. 1. The dataset corresponds to a particular MCC. For another MCC, another dataset is acquired. For example, where a user wishes to create a visual representation of a given MCC, the interface service obtains the dataset corresponding to that given MCC. The interface service may read the dataset directly from storage or may query another entity for the dataset (e.g., an entity associated with a design and ordering process for the MCC). In some cases, the interface service may read or retrieve the dataset from data storage resources.

The interface service then parses the dataset in order to generate a project file (step 705). To parse the dataset, the interface service may leverage a parsing engine (e.g., parsing engine 607 of FIG. 6). As illustrated in FIG. 7, step 705 includes a number of constituent steps. To parse the dataset to generate the project file, the interface service begins by identifying, from the dataset, sections of the MCC corresponding to the dataset and units for each of the sections (step 705a). In some cases, the type of the MCC is used to inform the selection of a type-specific graphic library corresponding to the MCC type. In such cases, graphics for the various elements of the visual representation are chosen from the associated type-specific graphic library. The MCC associated with the dataset may contain any number of sections and the sections may contain multiple units of various form factors. For each of the sections of the MCC, the interface service then selects a section header graphic for each section (step 705b). For example, a section header may include a section name, such as “section one.” The interface service then selects a top wireway graphic for each section (step 705c).

The interface service then selects a unit graphic for each of the units of each of the sections of the MCC (step 705d). The interface service then selects a bottom wireway for each section of the MCC (step 705e). For each of the unit graphics of each section, the interface service initialize the unit graphics for each of the units of each of the section (step 705f). To initialize the unit graphics, the interface service obtains status information for devices of the MCC and configures visual elements of the unit graphics such that they correspond to state information for the devices of the MCC. Based on the selected graphics and initialized configurations, the interface service generates the project file (step 705g).

The project file generated by the interface service corresponds to the MCC defined in the dataset, and when executed, triggers the display of a visual representation of the MCC (e.g., visual representation 617 of FIG. 6). The interface service, having generated the project file, deploys the project file to a terminal for execution and subsequent display of the visual representation (step 707). In some cases, the terminal is a physical device on the same premises as the MCC. In some cases, the terminal is located remotely to the MCC. In some cases, the terminal is a browser-based terminal.

FIG. 8 illustrates computing system 805 used in accordance with some embodiments of the present technology. Computing system 805 is representative of a computing device sufficient to execute software and communicate with peripherals. Computing system 805 is representative of any system or collection of systems with which the various operational architectures, processes, scenarios, and sequences disclosed herein. Computing system 805 may be implemented as a single apparatus, system, or device or may be implemented in a distributed manner as multiple apparatuses, systems, or devices.

Computing system 805 includes, but is not limited to, processing system 825, storage system 810, software 815, communication interface system 820, and user interface system 830. Processing system 825 is operatively coupled with storage system 810, communication interface system 820, and user interface system 830. Computing system 805 may be representative of a cloud computing device, distributed computing device, or the like.

Processing system 825 loads and executes software 815 from storage system 810. Software 815 includes and implements interface service 835. When executed by processing system 825 to provide interface service 835, software 815 directs processing system 825 to operate as described herein for at least the various processes, operational scenarios, and sequences discussed in the foregoing implementations. Computing system 805 may optionally include additional devices, features, or functionality not discussed for purposes of brevity.

Processing system 825 may include a microprocessor and other circuitry that retrieves and executes software 815 from storage system 810. Processing system 825 may be implemented within a single processing device but may also be distributed across multiple processing devices or sub-systems that cooperate in executing program instructions. Examples of processing system 825 include general purpose central processing units, graphical processing units, application specific processors, and logic devices, as well as any other type of processing device, combinations, or variations thereof.

Storage system 810 may include any computer readable storage media readable by processing system 825 and capable of storing software 815. Storage system 810 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations, storage system 810 may also include computer readable communication media over which at least some of software 815 may be communicated internally or externally. Storage system 810 may be implemented as a single storage device but may also be implemented across multiple storage devices or sub-systems co-located or distributed relative to each other. Storage system 810 may include additional elements, such as a controller capable of communicating with processing system 825 or other systems.

Software 815 (including interface service 835) may be implemented in program instructions and, when executed by processing system 825, can direct processing system 825 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 815 may include additional processes, programs, or components, such as operating system software, virtualization software, or other application software. Software 815 may also include firmware or some other form of machine-readable processing instructions executable by processing system 825.

In general, software 815 may, when loaded into processing system 825 and executed, transform a suitable apparatus, system, or device (of which computing system 805 is representative) overall from a general-purpose computing system into a special-purpose computing system customized to provide interface service 835 as described herein. Indeed, encoding software 815 on storage system 810 may transform the physical structure of storage system 810. The specific transformation of the physical structure may depend on various factors in different implementations of this description. Examples of such factors may include, but are not limited to, the technology used to implement the storage media of storage system 810 and whether the computer-storage media are characterized as primary or secondary storage, as well as other factors.

For example, if the computer readable storage media are implemented as semiconductor-based memory, software 815 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 820 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The media, connections, and devices are well known and need not be discussed at length here.

Communication between computing system 805 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The communication networks and protocols are well known and need not be discussed at length here.

While some examples provided herein are described in the context of an industrial environment, it should be understood that the systems and methods described herein are not limited to such embodiments and may apply to a variety of other industrial environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method for automatically generating a visual representation of a motor control center (MCC), the method comprising:
accessing, by an interface service, a dataset for the MCC, wherein the dataset defines a configuration of the MCC, wherein the configuration includes at least:
one or more units of the MCC, and
a form factor and location within the MCC for each unit of the one or more units;
parsing, by the interface service, the dataset to generate a project file for the MCC, wherein the project file defines the visual representation of the MCC including the form factor and the location within the MCC for each of the one or more units; and
deploying the project file to a terminal for execution, wherein executing the project file displays the visual representation of the MCC.

2. The method of claim 1, wherein parsing the dataset comprises:
identifying, from the dataset, sections of the MCC;
selecting, for each of the sections, a section header graphic;
selecting, for each of the sections, a top wireway graphic;
identifying, for each of the sections, the one or more units;
selecting, for the one or more units, unit graphics based at least in part on a form factor of the respective unit, wherein the unit graphics comprise configurable visual elements that indicate a state of a corresponding unit;
selecting, for each of the sections, a bottom wireway graphic;
initializing, for each of the one or more units, the configurable visual elements of the unit graphics; and
generating, based on the section header graphic for each of the one or more sections, the top wireway graphic for each of the one or more sections, the unit graphics for each of the one or more units, and the bottom wireway graphic for each of the one or more sections, the project file.

3. The method of claim 2, wherein the configurable visual elements that indicate the state of the corresponding unit comprise:
a configurable visual element that indicates a network connection state of the corresponding unit; and
a configurable visual element that indicates a fault state of the corresponding unit.

4. The method of claim 3, further comprising:
periodically obtaining network connection information for the corresponding unit;
periodically obtaining fault information for the corresponding unit; and
modifying, based on the network connection information and the fault information, the configurable visual elements to indicate the fault state for the corresponding unit.

5. The method of claim 4, wherein each of the section header graphic for each of the one or more sections, the top wireway graphic for each of the one or more sections, the unit graphics for each of the one or more units, and the bottom wireway graphic for each of the one or more sections comprise a scalable vector graphic (SVG).

6. The method of claim 1, further comprising:
receiving, at the interface service, a request for the visual representation for the MCC, wherein each of accessing the dataset, generating the project file, and deploying the project file are performed in response receiving the request for the visual representation for the MCC.

7. The method of claim 1, further comprising:
receiving, at the interface service, a request to update the visual representation for the MCC, wherein each of accessing the dataset, generating the project file, and deploying the project file are reperformed in response receiving the request to update the visual representation for the MCC.

8. The method of claim 1, wherein deploying the project file to the terminal comprises deploying the project file to the terminal via a cloud-based service.

9. The method of claim 1, wherein the dataset is generated during an order and design process for the MCC.

10. A computing device comprising:
one or more computer readable storage media;
one or more processors operatively coupled with the one or more computer readable storage media; and
program instructions stored on the one or more computer readable storage media that, when read and executed by the one or more processors, direct the computing device to at least:
access a dataset for a motor control center (MCC), wherein the dataset defines a configuration of the MCC, wherein the configuration includes at least: one or more units of the MCC, and
a form factor and location within the MCC for each unit of the one or more units;
parse the dataset to generate a project file for the MCC, wherein the project file defines a visual representation of the MCC including the form factor of the respective unit and the location within the MCC of the respective unit for each of the one or more units; and
deploy the project file to a terminal for execution, wherein executing the project file displays the visual representation of the MCC.

11. The computing device of claim 10, wherein the program instructions directing the computing device to parse the dataset comprises further comprise instructions that, when executed, direct the computing device to:
identify, from the dataset, sections of the MCC;
select, for each of the sections, a section header graphic;
select, for each of the sections, a top wireway graphic;
identify, for each of the sections, the one or more units;
select, for the one or more units, unit graphics, wherein the unit graphics comprise configurable visual elements that indicate a state of a corresponding unit;
select, for each of the sections, a bottom wireway graphic;
initialize, for each of the one or more units, the configurable visual elements of the unit graphics; and
generate, based on the section header graphic for each of the one or more sections, the top wireway graphic for each of the one or more sections, the unit graphics for each of the one or more units, and the bottom wireway graphic for each of the one or more sections, the project file.

12. The computing device of claim 11, wherein the configurable visual elements that indicate the state of the corresponding unit comprise:
a configurable visual element that indicates a network connection state of the corresponding unit; and
a configurable visual element that indicates a fault state of the corresponding unit.

13. The computing device of claim 12, wherein the program instructions further comprise instructions that, when executed, direct the computing device to:
periodically obtain network connection information for the corresponding unit;
periodically obtain fault information for the corresponding unit; and
modify, based on the network connection information and the fault information, the configurable visual elements to indicate the fault state for the corresponding unit.

14. The computing device of claim 13, wherein each of the section header graphic for each of the one or more sections, the top wireway graphic for each of the one or more sections, the unit graphics for each of the one or more units, and the bottom wireway graphic for each of the one or more sections comprise a scalable vector graphic (SVG).

15. The computing device of claim 10, wherein the program instructions further comprise instructions that, when executed, direct the computing device to:
receive, at the computing device, a request for the visual representation for the MCC, wherein each of accessing the dataset, generating the project file, and deploying the project file are performed in response receiving the request for the visual representation for the MCC.

16. The computing device of claim 10, wherein the program instructions further comprise instructions that, when executed, direct the computing device to:
receive, at the computing device, a request to update the visual representation for the MCC, wherein each of accessing the dataset, generating the project file, and deploying the project file are reperformed in response receiving the request to update the visual representation for the MCC.

17. The computing device of claim 10, wherein the program instructions directing the computing device to deploy the project file to the terminal further comprise instructions that, when executed, direct the computing device to:
deploy the project file to the terminal via a cloud-based service.

18. The computing device of claim 10, wherein the dataset is generated during an order and design process for the MCC.

19. One or more computer readable storage media having program instructions stored thereon that, when read and executed by one or more processors of a computing device, direct the computing device to at least:
access a dataset for a motor control center (MCC), wherein the dataset defines a configuration of the MCC, wherein the configuration includes at least:
one or more units of the MCC, and
a form factor and location within the MCC for each unit of the one or more units;
parse the dataset to generate a project file for the MCC, wherein the project file defines a visual representation of the MCC including the form factor and the location within the MCC for each of the one or more units; and
deploy the project file to a terminal for execution, wherein executing the project file displays the visual representation of the MCC.

20. The one or more computer readable storage media of claim 19, wherein the program instructions further comprise instructions that, when executed, direct the computing device to:
identify, from the dataset, sections of the MCC;
select, for each of the sections, a section header graphic;
select, for each of the sections, a top wireway graphic;
identify, for each of the sections, the one or more units;
select, for the one or more units, unit graphics, wherein the unit graphics comprise configurable visual elements that indicate a state of a corresponding unit;
select, for each of the sections, a bottom wireway graphic;
initialize, for each of the one or more units, the configurable visual elements of the unit graphics; and
generate, based on the section header graphic for each of the one or more sections, the top wireway graphic for each of the one or more sections, the unit graphics for each of the one or more units, and the bottom wireway graphic for each of the one or more sections, the project file.
